(19) United States
(12) Patent Application Publication
(10) Pub. No.: US 2010/0199012 A1
(43) Pub. Date: Aug. 5, 2010

(54) System for connecting an external device to a serial flexray data bus

(76) Inventor: Robert Hugel, Karlsruhe (DE)

Correspondence Address: KENYON & KENYON LLP, ONE BROADWAY, NEW YORK, NY, 10004, US

(21) Appl. No.: 12/308,325

(22) PCT Filed: Jan. 22, 2008
(86) PCT No.: PCT/EP2008/050679

§ 371 Date: Apr. 20, 2010

(51) Int. Cl. G06F 13/14

(52) U.S. Cl. 710/305

(57) ABSTRACT

A system for connecting an external device to a serial FlexRay data bus using which data are transmitted over two data lines as a voltage difference signal, the external device being decoupled from the serial FlexRay data bus by an active star circuit to preserve the signal integrity of the voltage difference signal.

### BACKGROUND OF THE INVENTION

1. Field of the Invention

The present invention relates to a system for connecting an external device to a serial FlexRay data bus, in particular for connecting an external test device for diagnosing a FlexRay data bus installed in a motor vehicle.

2. Description of Related Art

Test devices requiring access to an internal bus system installed in a motor vehicle are used in automotive repair shops for error diagnosis. The test devices analyze the data traffic transmitted to the bus, i.e., so-called bus monitoring is performed. Conventional bus systems such as CAN or LIN have a relatively low data transmission rate. For example, CAN has a maximum data transmission rate of about 1 Mbit/s. In the case of such conventional data buses, it is therefore possible to connect external test devices directly to the serial bus without severe constraints on the signal quality, although the connected device distorts the signal transmitted to the data bus due to its own capacitance and the inductance of its connecting lines.

However, because of the high data transmission rate of a FlexRay data bus it is no longer possible to connect a test or diagnostic device directly to the serial FlexRay data bus, since the signal quality is reduced so severely by the capacitance or by the inductance of the connected test device that the error rate rises sharply during data transmission via the serial FlexRay data bus when the external device is connected.

### BRIEF SUMMARY OF THE INVENTION

An object of the present invention is to provide a system that permits the connection of an external device to a serial FlexRay data bus.

The present invention provides a system for connecting an external device to a serial FlexRay data bus on which data are transmitted over two data lines as a voltage difference signal, the device being decoupled from the rest of the serial FlexRay data bus by an active star connection to maintain the signal integrity of the voltage difference signal.

In one example embodiment of the system according to the present invention, the active star connection has at least two bus driver circuits and one internal signal multiplexer.

In one example embodiment of the system according to the present invention, each bus driver circuit has:

a voltage source to produce a signal level which indicates that no signal is being transmitted over the serial bus,

a push-pull final stage to produce a transmitting voltage difference signal,

a window comparator to generate a wake-up signal when a “wakeup symbol” is received, and

a Schmitt trigger to generate a receiving voltage difference signal.

In one example embodiment of the system according to the present invention the voltage difference signal has a signal excursion from about +/−500 mV to about +/−1 V auf.

In one example embodiment of the system according to the present invention, the data are transmitted over the serial FlexRay data bus at a data transmission rate of 10 Mbit/s.

In one example embodiment of the system according to the present invention, the active star connection amplifies a data signal received from a bus driver circuit and forwards the received data signal over all other bus driver circuits in amplified form using the push-pull final stage.

In one example embodiment of the system according to the present invention the device is a test device for analyzing the difference signal transmitted on the serial FlexRay data bus.

### BRIEF DESCRIPTION OF THE SEVERAL VIEWS OF THE DRAWINGS

FIG. 1 shows an example of a topology of a FlexRay data bus to illustrate the system according to the present invention.

FIGS. 2A, 2B show various topologies of a FlexRay data bus to illustrate the operating principle of the system according to the present invention.

FIG. 3 shows a block diagram of an example embodiment of the system according to the present invention for connecting an external device to a serial FlexRay data bus.

FIG. 4 shows another example of a FlexRay data bus, which has the system according to the present invention for connecting an external device.

### DETAILED DESCRIPTION OF THE INVENTION

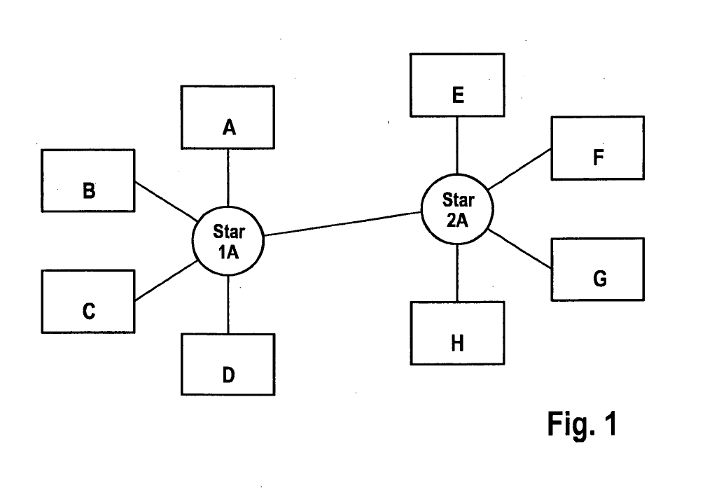

FIG. 1 shows an example of a topology of a FlexRay data bus. The FlexRay data bus is a serial data bus with which data are transmitted over two data lines as voltage difference signals, the two data lines being installed as a twisted pair, for example in a body of a vehicle. The bus protocol of the FlexRay data bus permits various nodes or control devices in the vehicle to communicate with each other flexibly under tough realtime demands. The data transmission rate in a FlexRay data bus is around 10 Mbit/s, significantly higher than with conventional serial bus systems in motor vehicles. A rigidly defined transmission time during a time-controlled operating mode and event-oriented data transmission during the rest of the time provide for relatively high flexibility and reliability during the transmission of data. A FlexRay data bus system contains various components, in particular passive stars, bus drivers and active stars. Additional components include, for example, termination networks, ESD protection circuits and common mode filters.

In the example of a FlexRay bus system depicted in FIG. 1, two active stars or star circuits are joined together via a FlexRay bus, there being a plurality of nodes or control devices of the bus system connected to each star. The active stars operate as multidirectional signal amplifiers without a timing refresh. As long as no message is being sent, all arms or branches of the FlexRay data bus are monitored for activity. If an activity is detected on an arm, all other arms are configured for forwarding the data signal.

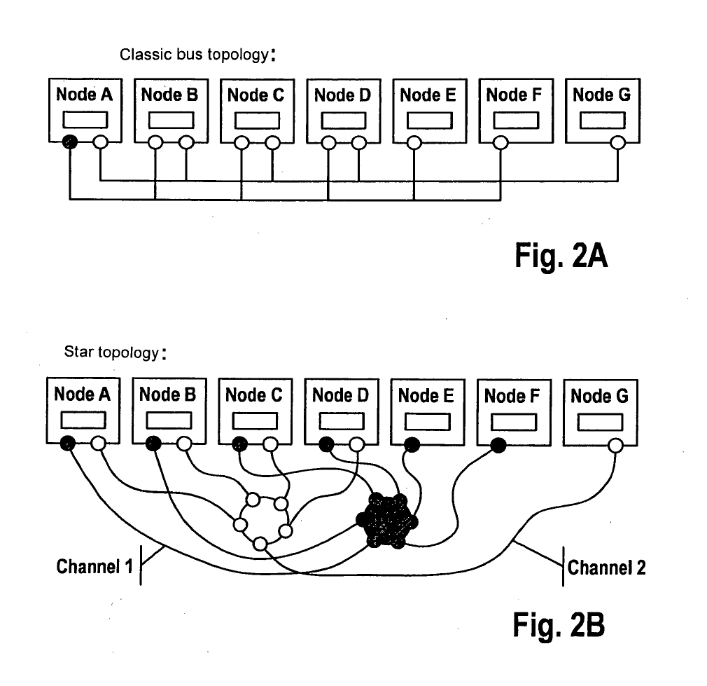

FIGS. 2A, 2B show a plurality of topologies of a FlexRay data bus system. The network may be set up flexibly in a classic bus topology, as shown in FIG. 2a, or in a star topology, as shown in FIG. 2B.

In one example embodiment, the FlexRay data bus system has two channels, which enable redundant data transmission or data transmission designed more for bandwidth. An additional monitoring mechanism known as a bus guardian prevents malfunctions by allowing each node bus access to send a message or note at fixed times. As can be seen in FIG. 2B, various control devices or nodes are networked together partially redundantly through active star circuits and two channels. The data are transmitted to the serial FlexRay data bus in frames. The control devices or nodes are synchronized using transmitted synchronization messages. The data frames are transmitted to the data bus in time slots, one or more time slots being assigned to each node or control device. The control devices or nodes connected to the serial data bus listen in on the data traffic transmitted via the bus.

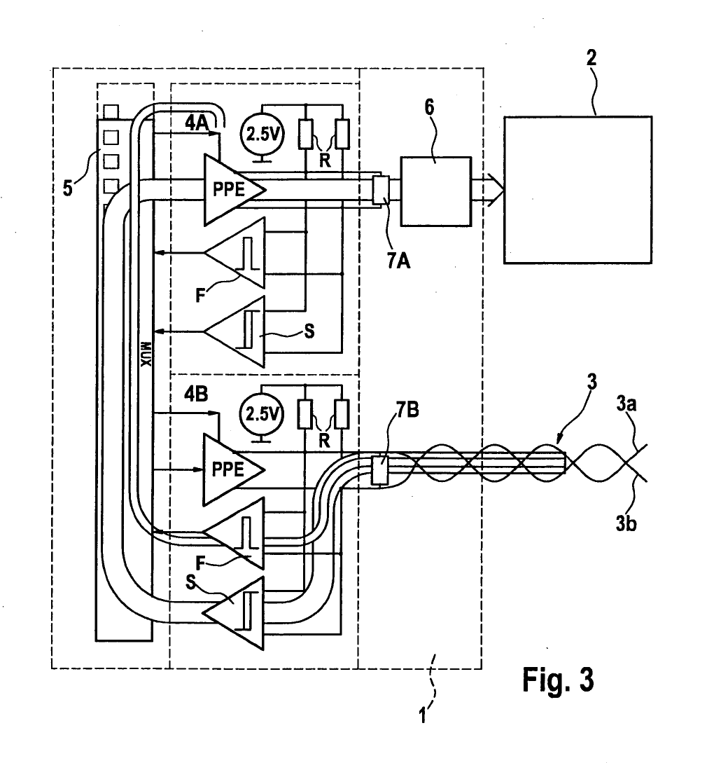

FIG. 3 shows a schematic diagram to illustrate an example embodiment of system 1 according to the present invention for connecting an external device 2 to a serial FlexRay data bus 3 on which data are transmitted over two data lines 3a, 3b as voltage difference signals. Data transmission lines 3a, 3b consist, for example, of twisted lines. System 1 according to the present invention decouples device 2 from serial FlexRay data bus 3 to preserve the signal integrity of the reference data signal transmitted on serial data bus 3. To that end the system according to the present invention has an integrated active star circuit with at least two bus driver circuits 4A, 4B and a signal multiplexer circuit 5. System 1 has a socket 6 for connecting external device 2 to bus driver circuit 4A.

Each of the two bus driver circuits 4A, 4B shown in FIG. 3 has a voltage source to produce a signal level of about 2.5 V, which indicates that no signal is being transmitted, i.e., a so-called IDLE condition is indicated, in which the data bus is free. Furthermore, each of the two bus driver circuits 4A, 4B contains a push-pull final stage PPE to produce a transmitting voltage difference signal, the push-pull final stages each being activatable and deactivatable. In addition, the two bus driver circuits 4A, 4B each have a window comparator to produce a wake-up signal. Furthermore, a Schmitt trigger S is provided in each of the bus driver circuits 4A, 4B to regenerate the reception reference data signal. The two connections are monitored by relatively slow window comparators F. The note or message itself is forwarded via relatively fast Schmitt trigger S. In the specific embodiment depicted in FIG. 3, internal signal multiplexer 5 switches bus driver circuit 4B, which is connected to FlexRay data bus 3, to bus driver circuit 4A for external test device 2, which is connectable via socket 6. In a preferred specific embodiment, signal multiplexer 5 or internal switching device 5 is configurable. As can be seen in FIG. 3, terminating resistors 7A, 7B are provided, preferably ohmic resistors, to minimize signal reflections. Furthermore, the voltage source is connected to the data transmission lines via push-pull resistors. Under an ohmic load, the transmitted difference voltage on the bus is typically +/−500 mV to +/−1 V. A difference signal is present at the bus lines. The voltage of approximately 0 V indicates that the bus is free (idle) and that no message is being sent. A negative voltage corresponds to the logical data bit value “0”. A positive voltage corresponds to the logical data bit value “1”. The data are transmitted serially over serial FlexRay data bus 3, preferably at a data transmission rate of 10 Mbit/s.

In the specific embodiment depicted in FIG. 3, system 1 according to the present invention has only two bus driver circuits 4A, 4B. In other specific embodiments more bus driver circuits 4 may also be provided, in particular to connect a plurality of test devices 2 to serial data bus 3.

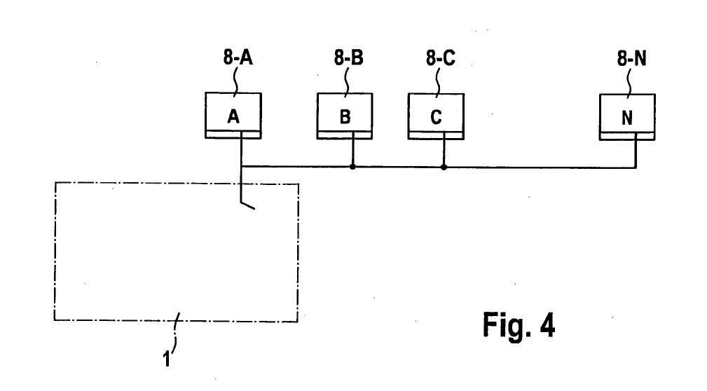

FIG. 4 shows an example of a FlexRay data bus system in which data are transmitted serially via data bus 3 between nodes or control devices 8-a, 8-b, 8-c, 8-n. An external device 2, in particular an external test device, may be connected via system 1 according to the present invention. With system 1 according to the present invention as depicted in FIG. 3, external test device 2 is decoupled or isolated from serial data bus 3 by the internal circuitry, i.e., the change in the signal level or the change in signal shaping on the one side does not change the signal level or signal form on the other side. If test device 2 is not connected to system 1, this has no influence on the signal transmission on serial data bus 3. The length of the connecting lines of test device 2 also has no effect on the transmission of data over serial data bus 3. Because of the decoupling between serial FlexRay data bus 3 and diagnostic device 2, signal integrity is maintained on serial data bus 3 even during the measuring process, so that the error rate of the test process is not higher than during normal operation. The signal transmitted to serial data bus 3 is not influenced by activation of the measuring system or external test device 2.

1-7. (canceled)

8. A connection system for connecting an external device to a serial FlexRay data bus, comprising:
an active star circuit (a) connecting the external device to at least two data lines of the FlexRay data bus and (b) decoupling the external device from the rest of the serial FlexRay data bus;
where in data are transmitted over the at least two data lines as a voltage difference signal, and wherein the external device is decoupled from the rest of the serial Flex-Ray data bus to preserve the signal integrity of the voltage difference signal.

9. The system as recited in claim 8, wherein the active star circuit has at least two bus driver circuits and one signal multiplexer.

10. The system as recited in claim 9, wherein each bus driver circuit includes:
a voltage source to produce a voltage level which indicates that no signal is being transmitted over the serial FlexRay data bus;
a push-pull final stage to produce a transmitting voltage difference signal;
a window comparator to produce a wake-up signal when a wake-up symbol is received; and
a Schmitt trigger to generate a receiving voltage difference signal.

11. The system as recited in claim 10, wherein the voltage difference signal has a signal excursion from about +/−500 mV to about +/−1 V.

12. The system as recited in claim 10, wherein the data are transmitted on the serial FlexRay data bus at a data transmission rate of 10 Mbit/s.

13. The system as recited in claim 10, wherein the active star circuit forwards a data signal received from a bus driver circuit via the remaining bus driver circuit using the respective push-pull final stage.

14. The system as recited in claim 10, wherein the external device is a test device configured to analyze the transmitted voltage difference signal.
